(19) United States
(12) Patent Application Publication
(10) Pub. No.: US 2025/0193989 A1
(43) Pub. Date: Jun. 12, 2025

(54) PATTERN-BASED OPTIMIZATION OF LIGHTING SYSTEM COMMISSIONING

(71) Applicant: SIGNIFY HOLDING B.V., EINDHOVEN (NL)

(72) Inventors: MANMATH NATH RAY, BANGALORE (IN); SANJEEV KUMAR PUVVADA SATHYANARAYANA, BANGALORE (IN)

(21) Appl. No.: 18/844,434

(22) PCT Filed: Feb. 27, 2023
(86) PCT No.: PCT/EP2023/054811

§ 371 Date: Sep. 6, 2024

(30) Foreign Application Priority Data
Mar. 8, 2022 (IN) 202241012539
Apr. 25, 2022 (EP) 22169736.0

(51) Int. Cl. H05B 47/175; H05B 47/11; H05B 47/115

(52) U.S. Cl. CPC H05B 47/1995; H05B 47/11; H05B 47/115; H05B 47/1985

(57) ABSTRACT

This invention relates to an apparatus (100) and method (400) for optimizing a commissioning process by using patterns (A, O) identified in a physical space where a lighting system is to be deployed, to thereby reduce complexity and time effort for commissioning lighting components and controls.

### FIELD OF THE INVENTION

The invention relates to the field of commissioning of lighting systems for use in various different applications for home, office, retail, hospitality and industry.

### BACKGROUND OF THE INVENTION

Lighting systems for areal illumination may comprise a set of “luminaires”, i.e., light fixtures comprising mounting hardware and one or more light-emitting components, such as incandescent or fluorescent bulbs or arrays of light-emitting diodes (LEDs)), together with one or more sensor components (motion sensors, light sensors, and the like), control devices (such as dimmers, switches or the like), and power drivers to set the output light level of each luminaire as a function of sensor outputs and control device settings. Such systems can range in complexity from a single wall switch and bulb to commercial building lighting systems comprising hundreds of luminaires, sensors, and control devices.

As the total number of components in a lighting system increases, sophisticated control systems may be desirable. A sophisticated control system may be implemented using electronic control systems, which may include custom electronics or software running on a more general-purpose control device such as a digital computer. A trained engineer may manually connect devices in the control system, provide a description of the system to the control system hardware and software, and identify the control functions to be implemented.

The term “commissioning” is often applied to lighting control system activation, or factory start-up, in which a manufacturer representative calibrates installed controls as a service. It may also be used to describe functional testing. Commissioning may by applied to an entire building and its energy-using systems, including lighting and controls. Commissioning may answer the question: “Does the building and its systems perform according to what the owner wanted and the designer intended?”. This may include the lighting control system, its functionality, and its sequence of operations, or what actions it performs as outputs (e.g., turn OFF the lights) in response to various inputs (e.g., occupancy). Furthermore, it may include the owner project requirements related to lighting control and what strategies will be implemented to satisfy these requirements, and the control system and sequence of operations for each space or general space type.

Thus, commissioning of lighting systems is not a trivial task and requires consideration of multiple parameters to provide a workable solution. Such parameters include lighting system parameters (e.g., luminaires, sensors, controllers, gateways, software clients, software servers, etc.) and physical space parameters (e.g., walls, locations, windows, room sizes, etc.) of the site where the system must be commissioned. Due to the plurality of parameters, the process can be become very complex and cumbersome.

### SUMMARY OF THE INVENTION

It is an object of the present invention to increase efficiency of a commissioning process.

This object is achieved by a commissioning apparatus as claimed in claim 1, by a commissioning system as claimed in claim 12, by a method as claimed in claim 13, and by a computer program product as claimed in claim 14.

According to a first aspect, an apparatus is provided, that is configured to:
detect repeatable patterns of a physical space of at least one of a non-commissioned lighting system and a commissioned lighting system based on installation and/or control data for commissioning the non-commissioned lighting system;
compare the detected repeatable patterns of the non-commissioned lighting system with stored installation and/or control data of at least one commissioned lighting system, wherein the at least one commissioned lighting system is different from the non-commissioned lighting system;
determine modelling data representative of portions similar to the detected repeatable patterns of the non-commissioned lighting system in the at least one commissioned lighting system and/or the non-commissioned lighting system, based on the result of the comparison;
determine configuration data required for commissioning the non-commissioned lighting network, based on the modelling data and the commissioning data of the at least one commissioned lighting system; and
using the determined configuration data for commissioning the non-commissioned lighting network.

According to a second aspect, a method of commissioning a lighting system is provided, the method comprising:
detecting repeatable patterns of a physical space of at least one of a non-commissioned lighting system and a commissioned lighting system based on installation and/or control data for commissioning the non-commissioned lighting system;
comparing the detected repeatable patterns of the non-commissioned lighting system with stored installation and/or control data of at least one commissioned lighting system, wherein the at least one commissioned lighting system is different from the non-commissioned lighting system;
determining modelling data representative of portions similar to the detected repeatable patterns of the non-commissioned lighting system in the at least one commissioned lighting system and/or the non-commissioned lighting system, based on the result of comparison;
determining configuration data required for commissioning the non-commissioned lighting network, based on the modelling data and the commissioning data of the at least one commissioned lighting system; and
using the determined configuration data for commissioning the non-commissioned lighting network.

According to a third aspect, a commissioning system is provided, that comprises the apparatus of the first aspect, a first interface arranged for receiving commissioning data from at least one commissioned lighting system, and a second interface for transmitting the determined configuration data to the non-commissioned lighting system for commissioning the non-commissioned lighting system.

According to a fourth aspect, a computer program product is provided, which comprises code means for producing the steps of the above method of the second aspect when run on a controller device.

Accordingly, the commissioning process can be optimized by using patterns identified in the physical space where a lighting system is to be deployed, to thereby derive available configuration information for commissioning and reduce complexity and time effort for commissioning lighting components and controls. More specifically, by determining repeatable patterns in the non-commissioned space, movements within the building for commissioning purposes can be minimized, overall commissioning time can be reduced, commissioning can be facilitated based on recommendations, and commissioning errors can be reduced.

The at least one lighting system commissioned in at least one building is intended to cover multiple commissioned lighting system without excluding just one such system.

According to a first option of any of the first to fourth aspects, the repeatable patterns may comprise at least one of areas and objects in a floor or building or site plan of the non-commissioned lighting system. Thus, a plan of a new space to be commissioned can be analyzed with respect to repeatable areas or objects in the plan of the new space or a plan of a commissioned space to derive previously available commissioning information or re-use commissioning information during the commissioning process.

According to a second option of any of the first to fourth aspects, which can be combined with the first option, a machine learning model may be used for detecting the repeatable patterns in a floor or building or site plan. Thereby, efficiency and reliability of the pattern detection process can be enhanced by applying artificial intelligence.

According to a third option of any of the first to fourth aspects, which can be combined with the first or second option, commissioning steps may be predicted based on at least one of user commissioning data, floor plan, distance of luminaire from user, project locations, relationship between areas, and user preference. This measure provides the advantage that the commissioning steps for a new commissioning project can be derived from identified patterns under consideration of commissioning criteria of the new project.

According to a fourth option of any of the first to fourth aspects, which can be combined with any one of the first to third options, the configuration data may be determined by taking into account commissioned features of a similar space in a similar building. Thus, available commissioned features of a similar project can be considered in a new commissioning project to reduce commissioning effort.

According to a fifth option of any of the first to fourth aspects, which can be combined with any one of the first to fourth options, the non-commissioned lighting system may be commissioned with regard to at least one of luminaires, sensors, controllers, gateways, software clients and software server. Thus, elements of a whole lighting control system can be commissioned in an effective manner.

According to a sixth option of any of the first to fourth aspects, which can be combined with any one of the first to fifth options, design rules of lighting commissioning may be optimized by equally applying a set of rules to identified similar portions and/or to optimize an effort for traversing the physical space for commissioning. Thereby, available rules of an earlier commissioned similar system can be applied in a new project to enhance efficiency.

According to a seventh option of any of the first to fourth aspects, which can be combined with any one of the first to sixth options, repeatable physical spaces may be identified at various granularity to apply various lighting rules for a granular space and replicate this across similar spaces. Thus, efficiency of the commissioning process can be enhanced by replicating commissioning steps for similar sub-spaces.

According to an eighth option of any of the first to fourth aspects, which can be combined with any one of the first to seventh options, the determined configuration data may comprise at least one of a number of luminaires, a number of daylight sensors, a number of occupancy sensors, a position of luminaires and sensors, a type of dynamic lighting configuration, a number of groups of luminaires and their light intensity, and a number of subgroups of luminaires and their light intensity. Thus, a detailed commissioning process that involves a wide range of aspects of the lighting systems can be provided.

According to a ninth option of any of the first to fourth aspects, which can be combined with any one of the first to eighth options, the similar portions may be identified based on at least one of a size of a room, a type of a room, a height of a room, an exposed area of a room, an ambient light of a room, positions of commissioned luminaires and/or sensors of a room, numbers of commissioned luminaires and/or sensors of a room, and number of groups and/or subgroups of luminaires in a room. Thereby, various criteria for identified similar portions are provided to enhance efficiency of the commissioning process.

According to a tenth option of any of the first to fourth aspects, which can be combined with any one of the first to ninth options, a dynamic light behavior of an area of the non-commissioned lighting network may be predicted based on at least one of a sensor type, a type of light, a position of the area in a floor map, and user behavior. Thus, rules for dynamic light control can be predicted based on similarities with commissioned systems to further enhance efficiency.

It is noted that the above apparatus may be implemented based on discrete hardware circuitries with discrete hardware components, integrated chips, or arrangements of chip modules, or based on signal processing devices or chips controlled by software routines or programs stored in memories, written on a computer readable media, or downloaded from a network, such as the Internet.

It shall be understood that the commissioning apparatus of claim 1, the commissioning system of claim 12, the method of claim 13, and the computer program product of claim 14 may have similar and/or identical preferred embodiments, in particular, as defined in the dependent claims.

These and other aspects of the invention will be apparent from and elucidated with reference to the embodiments described hereinafter.

### BRIEF DESCRIPTION OF THE DRAWINGS

In the following drawings:

FIG. 1 shows schematically a functional block diagram of a commissioning system according to various embodiments;

FIG. 2 shows a diagram of a device prediction system according to an embodiment;

FIG. 3 shows a diagram of a light recommendation system according to an embodiment; and

FIG. 4 shows a flow diagram of a commissioning method according to an embodiment.

### DETAILED DESCRIPTION OF EMBODIMENTS

Various embodiments of the present invention are now described based on a commissioning system for a lighting system. Although the present invention is particularly advantageous within the context of an illumination system, the invention is not limited thereto and may also be used within an optical wireless communication system that is integrated within an illumination system.

It is noted that—throughout the present disclosure—only those structural elements and functions are shown, which are useful to understand the embodiments. Other structural elements and functions are omitted for brevity reasons.

In the present disclosure, a light source may be understood as a radiation source that generates visible or non-visible light (i.e., including infrared (IR) or ultraviolet (UV)) light sources) for illumination and/or communication purposes. The light source may be included in a luminaire, such as a recessed or surface-mounted incandescent, fluorescent or other electric-discharge luminaires. Luminaires can also be of the non-traditional type, such as fiber optics with the light source at one location and the fiber core or “light pipe” at another.

Conventional light source luminaires are rapidly being replaced by light emitting diode (LED) based lighting solutions. Thus, an illumination infrastructure may be positioned in such a manner that it provides a line of sight from the luminaire to locations where people tend to reside. As a result, the illumination infrastructure may as well be positioned to provide optical wireless communication that likewise requires line of sight.

In the present disclosure, commissioning data is used to refer to installation data (e.g., data about nodes or devices and their locations in a building) and control data (e.g., data about control rules for operating the lights in the building). Furthermore, modelling data corresponds to data representative of commissioning data in similar portions (repeatable patterns) of two or more lighting systems, and configuration data corresponds to data representative of control rules of a commissioned lighting system to be provided to a similar portion of a non-commissioned lighting system.

An exemplary commissioning process may include the phases of equipment verification to confirm that an approved equipment has arrived in good order at the jobsite, installation verification to confirm that the equipment is installed according to approved drawings and plans (e.g. floor plans), system activation (also called factory startup) in which controls are programmed, calibrated and adjusted to match specifications and site conditions, functional testing to confirm that an installed equipment operates according to the design intent and achieves stated acceptance criteria, assignment of deficiencies to a punch list for resolution by the contractor, and owner notification and acceptance of all test reports.

Often during commissioning of lighting systems, it can be observed that a series of actions being performed for a specific location, area or space is also applicable to other areas of a physical target space or to another target space to be commissioned. For example, a commissioning process may be intended for a target office space with multiple meeting rooms of similar dimensions and infrastructure. If during the commissioning process, a series of actions has been done for commissioning one meeting room, these actions or the results thereof can be replicated for multiple similar meeting rooms, so that a workflow for commissioning can be optimized.

It is therefore proposed to optimize a commissioning workflow for e.g. a lighting system based on patterns identified in a physical target space. The identification can be supported by artificial intelligence (AI), such as machine learning algorithms and/or trainable neural networks.

A commissioning process supported by AI-based decision making may comprise a first step of data collection of earlier commissioning projects, e.g., by data generating devices connected to a server. This server may be configured for communicating with a cloud. It can be hosted either locally or in the cloud. In a subsequent step, after sufficient data has been collected, an AI model can be trained on the dataset to improve efficiency of new commissioning projects. That is, the output from the trained model can be used for making decisions regarding subsequent commissioning processes related e.g. to lighting control systems.

In an embodiment, the AI model can be trained to determine specific patterns in a database of earlier commissioned lighting systems, it can provide insights on the possibility of rearranging a floor layout to improve space utilization and/or reduce electricity costs by analyzing energy consumption of different luminaires and the pattern of people flow in different rooms.

If a supervised learning algorithm is used for pattern-based commissioning, a labeled dataset that contains both normal and anomalous patterns is required. Examples of supervised methods include pattern detection using neural networks, Bayesian networks, and the K-nearest neighbors (or k-NN) method. Supervised pattern detection may provide a better rate of pattern detection in the output signal thanks to its ability to encode any interdependency between variables and including previous data in any predictive model.

The AI-based pattern-based commissioning process may be implemented as an unsupervised learning algorithm that allows raw, unlabeled floor plan data to be used to train a pattern extraction process with little or no human involvement during the learning process. In unsupervised learning, the pattern detection function simply receives floor plan data of formerly commissioned systems to extract parameters and estimate commissioning results for identified patterns. Thus, no training data with manual labeling is required. Some of the unsupervised methods include the above K-means method, autoencoders, and hypothesis-based analysis. As a result, an improved AI-based parameter extraction and/or heart function estimation can be achieved for the real-time heart function quality tracking system or method, which is trained by a self-learning process and is thus readily available with little or no human involvement.

In an example, the AI model can be based on a convolutional neural network (CNN) for analyzing floor plans and installations of earlier commissioned lighting systems and extracting target parameters for identifying recurring patterns. The CNN is a regularized version of a multilayer neural network, which takes advantage of a hierarchical pattern in data and assembles patterns of increasing complexity using smaller and simpler patterns embossed in its filters. CNNs use relatively little pre-processing compared to other classification algorithms. This means that the network learns to optimize the filters (or kernels) through automated learning. This independence from prior knowledge and human intervention in feature extraction is a major advantage.

Another example for extracting target parameters for pattern detection using machine learning may be the so-called K-means clustering method which is a method of vector quantization that aims at partitioning N observations into K clusters in which each observation belongs to the cluster with the nearest mean (cluster centers or cluster centroid), serving as a prototype of the cluster. This results in a partitioning of the data space into cells. In an example, a parameter K (i.e., number of clusters) may vary from 3 to 20 depending on the resolution and the quality of patterns to be detected. This method can be used to detect outliers based on their plotted distance from the closest cluster. The K-means clustering method involves a formation of multiple clusters of data points each with a mean value. In the present case, such data points may be one-dimensional data points (e.g., clustering of patterns identified in floor plans based on their similarity) or two-dimensional data points (e.g., clustering in a two-dimensional plane of data patterns of a first parameter characteristic (e.g., size of a room) vs. a second parameter characteristic (e.g. number of luminaires) or three-dimensional data points (e.g., clustering in a three-dimensional space of data patterns of a first parameter characteristic (e.g., size of a room) vs. a second parameter characteristic (e.g., number of luminaires) vs. a third parameter characteristic (e.g., number of windows). Typical data patterns (i.e., patterns that often occur in floor plans) will then form cluster(s), while non-typical or anomalous data patterns (e.g., exotic patterns that seldomly occur in floor plans) will be located at a larger distance from the cluster of typical data patterns. Patterns within a cluster have the closest mean value. Any pattern with a threshold value greater than the nearest cluster mean value can be identified as an outlier. A step-by-step method used in K-means clustering may involve calculating a mean value of each cluster, setting an initial threshold value, determining the distance of each data point from the mean value during a testing process (learning phase), and identifying the cluster that is nearest to the test data point. If a distance value is more than a predetermined threshold value is then mark it as an outlier.

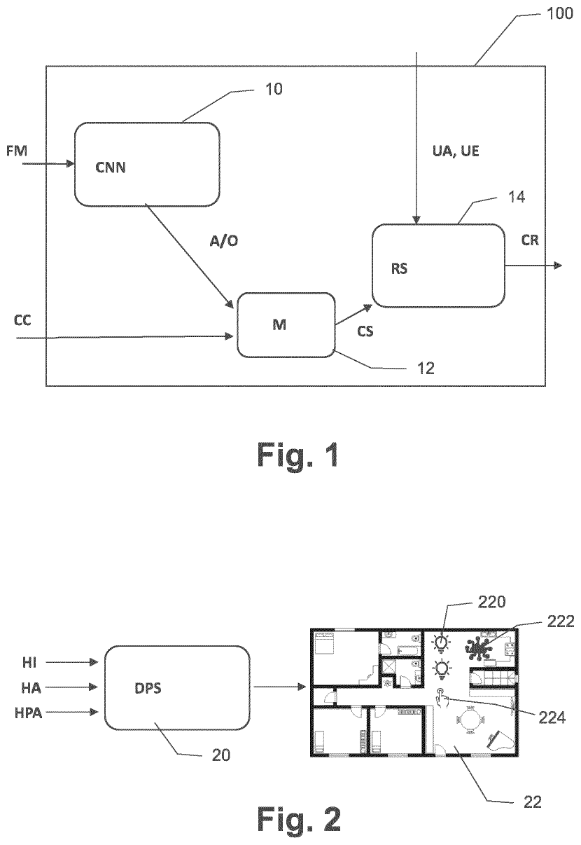

FIG. 1 shows schematically a functional block diagram of a commissioning apparatus 100 according to various embodiments. The functional blocks 10, 12 and 14 of the commissioning apparatus 100 may be implemented by at least one processor of an integrated or distributed computing system.

A CNN 10 is configured for detecting repeatable patterns (e.g., areas A and/or objects O) in a floor plan or map (FM) of a system to be commissioned, received via an interface (e.g., a user interface), and supplies the detected patterns to a commissioning model (M) 12 (which may also be based on an AI algorithm) which also receives via an interface (e.g. a user interface) commissioning criteria (CC) that comprise at least one of user commissioning data, required or desired distance of a luminaire from a user, user preferences, project locations, and spatial and/or functional relationships between areas. Based on the received detected patterns and commissioning criteria, the commissioning model 12 determines individual commissioning steps (CS) for at least some of the detected patterns.

In an example, the CNN 10 may be realized using faster region-based CNN (Faster R-CNN) or single-shot detector (SSD) or YOLO (“You Only Look Once”) architectures which can be deployed in computing or mobile devices.

Faster R-CNN is a deep convolutional network used for object detection, that appears to the user as a single, end-to-end, unified network. The network can accurately and quickly predict the locations of different objects. The Faster R-CNN algorithm builds a region-proposal network that can generate region proposals that are fed to a detection model (Fast R-CNN) to inspect for objects.

Alternatively, by using SSD, one a single shot of the floor map need to be processed to detect multiple objects within the image of the floor map, while regional proposal network (RPN) based approaches such as R-CNN series need two shots, one for generating region proposals, one for detecting the object of each proposal. Thus, SSD is faster compared with two-shot RPN-based approaches. In an example, SSD may be implemented to uses Resnet or Inception or mobileNet as feature network with grid sizes 38, 19, 10, 5, 3, 1.

The YOLO architecture employs a CNN to detect objects in real-time, while the algorithm requires only a single forward propagation through the CNN to detect objects. This means that prediction in an entire image can be done in a single algorithm run. The CNN is used to predict various class probabilities and bounding boxes simultaneously. The YOLO architecture can be built on e.g. DarkNet as an open source neural network framework with grid sizes 13, 26, 52. DarkNet is fast, easy to install, and supports CPU and GPU computation.

The commissioning model 12 may be implemented based on a regression model such as Extreme Gradient Boosting (XGBoost), which may be tuned to different hyper parameters based on its inputs. XGBoost is an open-source library that provides an efficient and effective implementation of the gradient boosting algorithm and can be used directly for regression predictive modeling.

The determined commissioning steps are then supplied to a recommendation system (RS) 14 that outputs via an interface (e.g., a user interface) a commissioning recommendation for a lighting system to be commissioned for the received floor map. The determined commissioning recommendation of the recommendation system 14 may be controlled by or dependent on user actions (UA) and/or a current user environment (UE) of the received floor map.

As a result, the efficiency of lighting commissioning workflows for the received floor map can increased (optimized) by first recognizing repeatable patterns of a physical space (i.e., floor map) to be commissioned before any other step of commissioning workflow is undertaken. The initial determination of repeatable patterns by the CNN 10 upfront allows to optimize design rules of lighting commissioning (e.g., one set of rules are equally applicable to other similar patterns) and/or to optimizing the effort for traversing the physical space of the received floor map for purpose of commissioning. This traversing corresponds to the so-called “travelling salesman problem” in operations research, where the shortest possible route that visits each city exactly once and returns to the origin city is searched.

The proposed system of FIG. 1 leverages advancements in AI to recognize repeatable patterns in a floor/building/site plan for both indoor and outdoor spaces.

More specifically, the CNN 10 or an equivalent algorithm or procedure can be configured to apply an AI model to an image of the received floor map (e.g., floor or building or site map) to identify different areas and different objects. The output of the AI model is an identification of repeatable physical spaces (e.g., blocks of meeting rooms, arrays of cubicles, a block of building in a street, etc.) at various granularity (e.g., within zones of a floor, across zones of a floor, across floors of a building etc.). This output can be presented to the commissioning model 12 or a user (commissioning engineer or any other subject matter expert) to apply various lighting rules for one of the identified patterns (i.e., granular space) and easily replicate this across identified similar spaces. As a subsequent prediction step applied by the commissioning model 12, commissioning steps (adapted to bring to life the above chosen rule) based on at least one of the received commission criteria.

The final commissioning recommendation by the recommendation system 14 may include a prediction of a dynamic light behavior based on at least one of a sensor type, a type of light, a location of the concerned pattern in the received floor map, and a user behavior. The dynamic light behavior may be a set of rules applied to a light output of a luminaire based on at least one of an output of an occupancy sensor and a light sensor. As an example, the dynamic light behavior may rule that a light output is changed (e.g., by/to x % of a previous light output) when an occupancy detected for 10 s. This rule is then configured in respective areas (patterns) during commissioning.

An objective of such dynamic light behavior rules can be to save energy and/or comply with security measures. The rules might change based on type of devices and sensors used.

Further examples of dynamic light behavior rules are:
Area auto on and auto off: When occupancy is detected in an area, all luminaires are switched to a fixed level (task level), while the luminaires are switched off if the area is vacant for more than a predetermined hold time.
Area auto on and auto off with daylight sensor: When occupancy is detected in an area, all luminaires are switched to a full-task level with daylight regulation.
Light auto on and auto off with daylight sensor: When occupancy is detected, selected luminaires are switched to a full-task level with daylight regulation, while other luminaires are switched to a background level.
Light auto on and auto off: When occupancy is detected, selected luminaires are switched to the full-task level, while other luminaires are switched to the background level.
Light manual on and auto off with daylight dependent regulation: After manually switching on, all luminaires are switched to the background level, while when an occupancy is detected, selected luminaires are switched to the full-task level with daylight regulation and other luminaires are switched to remain at the background level. When occupancy is detected longer than a dwell time, the luminaires are switched to the task level with daylight regulation.
Area auto on and auto off with scene control: All luminaires are switched to a defined light pattern or scene when occupancy is detected in the area.

FIG. 2 shows a diagram of a device prediction system (DPS) 20 according to an embodiment, which may be implemented in the recommendation system 14 of FIG. 1.

Devices to be commissioned for a specific area in a floor plan or map may be commissioned based on commissioning data from other projects (e.g., earlier commissioned systems).

The device prediction system 20 may receive as input data at least one of historical data (HI) from installations (e.g., number and/or type of devices per area unit), historical area data (HA) from installations (e.g., similar type of areas or pattern of areas), and historical area pattern data from installations (e.g., patterns of area and neighboring areas).

Based on the input data, the device prediction system 20 outputs a recommendation concerning at least one of types of devices (e.g., luminaires 220, switches 224, control or sensor networks 222, etc.) for an area 22, number of devices for the area 22, location of a device in the area 22, and a next area to be commissioned.

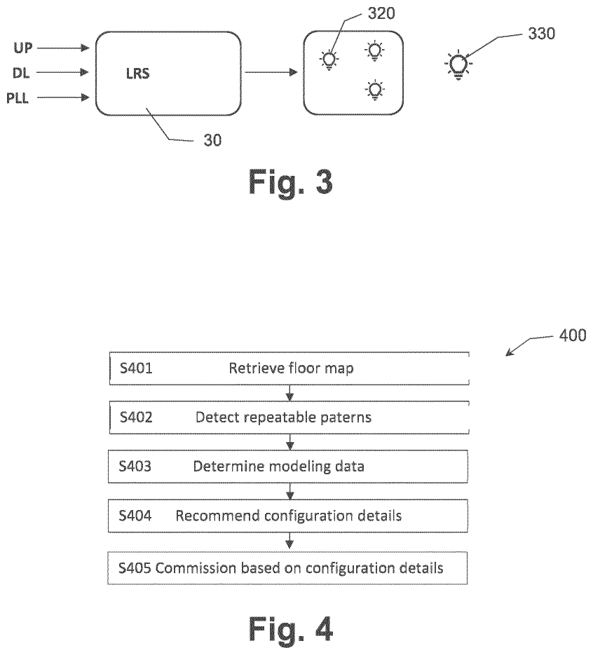

FIG. 3 shows a diagram of a light recommendation system (LRS) 30 according to an embodiment, which may be implemented in the recommendation system 14 of FIG. 1.

The light recommendation system 30 may be configured to provide an automatic recommendation of light sources 320 that can be grouped together (e.g., for common control), as opposed to light sources 330 outside the group.

The light recommendation system 30 may receive input information concerning at least one of a user position (UP), a required or desired distance (DL) between lights sources, a physical location (PLL) of a light source derived from a floor map or photo or camera output.

Such a recommendation concerning grouping of light sources reduces commissioning time and can be auto-commissioned based on the detected patterns without any user involvement.

FIG. 4 shows a flow diagram of a commissioning method 400 according to an embodiment.

In a first step S401, a floor map is received, which may be entered as a data set or scanned image or photo or the like.

Then, in step S402, repeatable patterns are detected based on similarities within the received floor plan or with one or more floor plans of previously commissioned systems. This can be achieved e.g. by applying an AI model as described above.

In a following steps S403, modeling data that defines individual commissioning steps of identified patterns based on commissioning criteria is determined and used in subsequent step S404 to recommend configuration details of identified patterns e.g. based on user actions or a current user environment.

Finally, in step S405 commissioning of the overall lighting system is performed based on configuration details of the identified patterns.

In an example, if a room A in a first building (commissioned) is used as a reference for commissioning another room B in a second building (not yet commissioned) and has the following features:
Size=x sqm, type=meeting room, height=h m, exposed area=2 walls exposed outside, ambient light measured on surface=/lm;
commissioned with n1 light sources, n2 occupancy sensor, n3 daylight sensors;
positioned at location L1 in the floor map,
g1 groups with t1 configurations, s2 sub-groups.

Based thereon, room “B” with similar features (i.e., identified pattern) can be recommended based on the above information as to the following questions:
1. How many light sources are required?
2. How many daylight sensors are required?
3. How many occupancy sensors are required?
4. What are suitable locations of light sources and sensors?
5. Which dynamic lighting configurations can be used?
6. How many light groups are required and what is their light intensity?
7. How many light sub-groups are required and what is their light intensity?

These predictions can then be auto-populated in the floor map for the new commissioning project for faster commissioning

However, if number of light sources in rooms A and B are not same, the commissioning model 12 in FIG. 1 can derive predictions for answering the above questions based on a closest matching room (identified pattern) with similar features.

The determination of the closest matching room (closest match) may be based on at least some of the above features of room A. The model 12 will base its approximation data based on these data.

To summarize, a system and method has been described for optimizing a commissioning process by using patterns identified in the physical space where a lighting system is to be deployed, to thereby reduce complexity and time effort for commissioning lighting components and controls.

While the invention has been illustrated and described in detail in the drawings and foregoing description, such illustration and description are to be considered illustrative or exemplary and not restrictive. The invention is not limited to the disclosed embodiments applied to lighting systems. It may as well be used for commissioning heating, ventilation and air-conditioning (HVAC) systems or security systems or other systems that can be commissioned.

Furthermore, multiple commissioned lighting systems may be considered, at least some of which are in different buildings. The modelling may then be performed centrally (e.g., in a cloud) and the learning may be performed across multiple systems/sites.

Other variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The foregoing description details certain embodiments of the invention. It will be appreciated, however, that no matter how detailed the foregoing appears in the text, the invention may be practiced in many ways, and is therefore not limited to the embodiments disclosed. It should be noted that the use of particular terminology when describing certain features or aspects of the invention should not be taken to imply that the terminology is being re-defined herein to be restricted to include any specific characteristics of the features or aspects of the invention with which that terminology is associated.

The described procedures like those indicated in FIGS. 1 to 4 can be implemented as program code means of a computer program and/or as dedicated hardware of the receiver devices or transceiver devices, respectively. The computer program may be stored and/or distributed on a suitable medium, such as an optical storage medium or a solid-state medium, supplied together with or as part of other hardware, but may also be distributed in other forms, such as via the Internet or other wired or wireless telecommunication systems.

1. A commissioning apparatus configured to:
detect, using a machine learning model, repeatable patterns of a physical space of a non-commissioned lighting system by identifying similar portions in a commissioned lighting system, wherein the non-commissioned lighting system is a lighting system where lighting controls are not activated and the commissioned lighting system is a lighting system where the lighting controls are activated;
compare, using a commissioning model, the detected repeatable patterns with installation data of at least one commissioned lighting system, wherein the at least one commissioned lighting system is different from the non-commissioned lighting system;
determine, using the commissioning model, modelling data representative of commissioning steps in portions similar to the detected repeatable patterns of the commissioned lighting system based on the result of the comparison;
determine, using a recommendation system, configuration data representative of recommendations of control rules required for commissioning the non-commissioned lighting system, based on the modelling data; and
using the determined configuration data for commissioning the non-commissioned lighting system.

2. The apparatus of claim 1, wherein the repeatable patterns comprise at least one of areas and objects in a floor or building or site plan of the non-commissioned lighting system.

3. The apparatus of claim 1, wherein the apparatus is configured to use a convolutional neural network as the machine learning model for detecting the repeatable patterns in a floor or building or site plan.

4. The apparatus of claim 1, wherein the apparatus is configured to predict commissioning steps based on at least one of, floor plan, distance of luminaire from user, relationship between areas of the physical space, and user preference.

5. The apparatus of claim 1, wherein the apparatus is configured to determine the configuration data by taking into account commissioned features of a space corresponding to the detected repeatable pattern in the commissioned lighting system.

6. The apparatus of claim 1, wherein the apparatus is configured to commission the non-commissioned lighting system with regard to at least one of luminaires, sensors, controllers, gateways, software clients and software server.

7. The apparatus of claim 1, wherein the apparatus is configured to optimize design rules of lighting commissioning by equally applying a set of rules to identified similar portions and/or to optimize an effort for traversing the physical space for commissioning.

8. The apparatus of claim 1, wherein the apparatus is configured to identify repeatable physical spaces at various granularity to apply various lighting rules for a granular space and replicate application of lighting rules across the identified repeatable physical spaces.

9. The apparatus of claim 1, wherein the determined configuration data comprises at least one of a number of luminaires, a number of daylight sensors, a number of occupancy sensors, a position of luminaires and sensors, a type of dynamic lighting configuration, a number of groups of luminaires and their light intensity, and a number of subgroups of luminaires and their light intensity.

10. The apparatus of claim 1, wherein the apparatus is configured to identify the similar portions based on at least one of a size of a room, a type of a room, a height of a room, an exposed area of a room, an ambient light of a room, positions of commissioned luminaires and/or sensors of a room, numbers of commissioned luminaires and/or sensors of a room, and number of groups and/or subgroups of luminaires in a room.

11. The apparatus of claim 1, wherein the apparatus is configured to predict a dynamic light behavior of an area of a non-commissioned lighting system based on at least one of a sensor type, a type of light, a position of the area in a floor map, and user behavior.

12. A commissioning system comprising the apparatus of claim 1, a first interface arranged for receiving commissioning data from at least one commissioned lighting system, and a second interface for transmitting the determined configuration data to the non-commissioned lighting system for commissioning the non-commissioned lighting system.

13. A method of commissioning a lighting system, the method comprising:
detecting, using a machine learning model, repeatable patterns of a physical space of a non-commissioned lighting system by identifying similar portions in a commissioned lighting system, wherein the non-commissioned lighting system is a lighting system where lighting controls are not activated and the commissioned lighting system is a lighting system where the lighting controls are activated;
comparing, using a commissioning model, the detected repeatable patterns of the non-commissioned lighting system with installation data of at least one commissioned lighting system, wherein the at least one commissioned lighting system is different from the non-commissioned lighting system;
determining, using the commissioning model, modelling data representative of commissioning steps in portions similar to the detected repeatable patterns of the commissioned lighting system based on the result of comparison;
determining, using a recommendation system, configuration data representative of recommendations of control rules required for commissioning the non-commissioned lighting system, based on the modelling data; and
using the determined configuration data for commissioning the non-commissioned lighting system.

14. A computer program product comprising code means for producing the steps of claim 13 when run on a processor.
